(19) United States
(12) Patent Application Publication
(10) Pub. No.: US 2011/0249999 A1
(43) Pub. Date: Oct. 13, 2011

(54) Keyboard with split layout

(76) Inventors: Andrew Boer, Mountlake Terrace, WA (US); Christopher Claiborne, Bellevue, WA (US)

(21) Appl. No.: 12/798,569

(22) Filed: Apr. 7, 2010

(51) Int. Cl. B41J 5/00

(52) U.S. Cl. 400/489

(57) ABSTRACT

An apparatus and layout for manual text entry on a small form factor information processing device provides a keyboard for data entry located on the back side of the device, opposite the side of the device facing the user. The keyboard assembly is further laid out as a split of the layout of the conventional standard form factor keyboard adapted to touch-typing, enabling users to employ touch-typing expertise acquired on standard keyboards on the small form-factor device.

### BACKGROUND OF THE INVENTION

1. Field of the Invention

This invention relates to assemblies utilized for manual data input for information technology devices, specifically keyboards. More particularly, this invention relates to a split keyboard assembly and layout for manual data input via back-typing.

2. Description of the Related Art

Over the years, the implementation of user data entry functionality for information technology devices has evolved steadily. Early technology for user input of data (including full text) in computing applications, in both batch-processing and timeshare implementations, employed adaptations of electronic keyboards from yet earlier teletype and related electronic arts, generally as stand-alone devices in communication with the computer system. Later implementations that provided video displays for data output (common in evolving timeshare and dedicated systems), employed either stand-alone keyboards constructed specifically for computer data entry or keyboards integrated with cathode ray tube displays to form video display terminals designed for human-computer communications.

With the emergence of the desktop personal computer, while some implementations (such as the early Radio Shack® TRS-80 Model III) integrated electronic keyboards with display and other components analogous to the integrated video display terminal form factor, stand-alone keyboards along the lines of those employed in earlier timeshare and dedicated systems became ubiquitous for user data entry. Further, laptop computers, comprising in essence a flat display hingeably and electronically connected to an integrated keyboard and computing apparatus, were developed and widely adopted.

With notable but rare exceptions, the layout of the keyboard for languages employing the Roman alphabet remained the same: the familiar QWERTY layout, first specified for manual typewriters, as set forth in U.S. Pat. No. 207,559 in 1878 to Sholes. The QWERTY layout, adopted by E. Remington & Sons for their widely marketed original manual typewriters, had become the worldwide standard layout for Roman alphabet typewriters long before the advent of electronic computers. Typists were trained in “touch-typing”, wherein, based upon tactile feedback and proprioception, with practice typists acquired “muscle-memory” of the placement of the keys in the QWERTY layout, enabling the trained typist to use QWERTY configured keyboards to type text very quickly without requiring the typist to look at the keyboard for visual cues to determine the location of the key corresponding to a particular letter. As typewriter technology was adopted for languages written in characters other than the Roman alphabet, standard layouts for such characters were also usually adopted. As a consequence, touch-typing became a widespread technique for typing worldwide.

Because touch-typing had long been commonplace by the time a need developed for user data entry in computing, and because computing technologies emerged primarily in countries with Roman alphabet based writing, the QWERTY layout from typewriter technology was carried over to the computer keyboard (again, with some exceptions), such keyboards providing tactile feedback to enable users to apply touch-typing proficiency already acquired on typewriters to computer keyboards for data entry applications.

With the evolution of computing systems through the desktop and laptop personal computer, the orientation of the keyboard with respect to the user remained roughly the same as it had been for typewriters: the keyboard was laid out on a roughly horizontal plane, intended for use while relatively stationary, with the QWERTY layout facing up. In this orientation, the user enters data by downward keystrokes of the fingers onto the upward-facing keys of the keyboard. In normal operation, such a keyboard is wide enough for the user to place hands palm-down, fingers extended, side-by side for touch-typing operation, or roughly at least seven inches or so (and often much wider) across.

Recent developments in the form factors used for information technology devices have significantly changed user data input device requirements, particularly for the full text data input functionality that was provided in the prior art by the stationary, upward facing QWERTY keyboard arrangement. Information technology devices have evolved to include devices with a small form factor, suitable for handheld operation: media players, personal digital assistants, smart-phones, and the like, as well as certain controllers for video game consoles and sophisticated home media systems. Such apparatus, including dedicated information processing devices and their peripherals (referred to collectively herein as “devices”) are now commonplace. While these devices are widely diverse in functionality and form factor, the majority share certain characteristics.

Most significantly for user input functionality, because they are designed for handheld operation, handheld devices are generally smaller (and usually much smaller) along any dimension than the standard width of a keyboard suitable for touch-typing. Because their smaller form factors are not wide enough to accommodate the side-by-side hand placement used in prior art input devices adapted for touch-typing, heretofore touch-typing has not been possible on these smaller devices. Instead, various alternative data entry technologies have been employed.

Most handheld devices have a display screen on one face. Some such display screens are touch-sensitive, enabling users to provide input by touching a finger or a stylus to specific areas on the screen. In some applications for some handheld devices with touch-sensitive screens, a data input screen layout is displayed, including in some cases a variation on the familiar QWERTY key layout, that enables a user to input data by employing a “hunt-and-peck” technique using the visual cues supplied by the display of the layout. Because of the small size of the layout, however, and because touch-screen input does not, in general, provide tactile feedback, such keyboards are not adapted for touch-typing, even when configured in the QWERTY key layout. Not surprisingly, the rate of text input on such keyboards does not even approach the rate of text input for an experienced typist on a full sized keyboard that is configured for touch-typing.

Alternatively, some handheld devices use a keyboard or keypad with a reduced number of keys for text entry, including particularly cellular telephones, with their characteristic three-by-four button layout. Some such devices rely on multi-tap technologies, where successive taps to a single key are mapped to a specified sequence of letters, the user selecting the desired letter by tapping a single key an appropriate number of times. Other such devices rely on predictive text technologies, such as T9 (described in U.S. Pat. No. 5,818,437), where the computing device algorithmically predicts the most probable characters desired by the user based on known frequencies of characters and words in the user's language. In part because the keypads on such devices are usually capable of providing tactile feedback, with significant practice a user's rate of text input on such reduced character input devices can approach that of a beginning to intermediate touch-typist. However, extensive text entry on such reduced key devices is laborious and, in any case, does not take advantage of the widespread expertise in touch-typing acquired on conventional keyboards described above.

What is needed is a data input technology that is adapted to the smaller form factor of handheld information technology devices while advantageously enabling experienced typists to employ already acquired expertise in touch-typing for rapid and efficient text entry.

### BRIEF DESCRIPTION OF THE INVENTION

The present invention is an apparatus and layout for manual text entry on a small form factor information processing device in which the keyboard for data entry is located on the back side of the device, opposite the side of the device that normally faces the user during text entry. The present invention further lays out the keyboard assembly as a split of the layout of the conventional standard form factor keyboard, enabling users to employ touch-typing expertise acquired on standard keyboards on the small form-factor device.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a diagram of the layout for a keyboard in an embodiment of the invention;

FIG. 2a depicts the front side of an embodiment of the invention;

FIG. 2b depicts the front side of an alternative embodiment of the invention; and

FIG. 2c depicts the back side of an embodiment of the invention showing the layout of the keyboard.

### DETAILED DESCRIPTION OF THE PREFERRED EMBODIMENTS

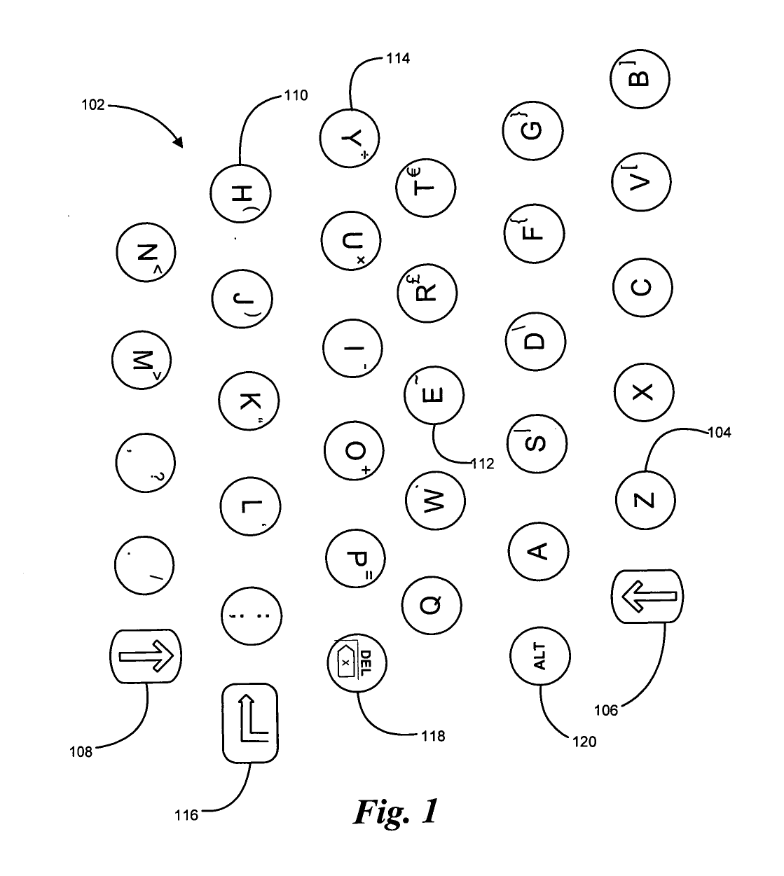

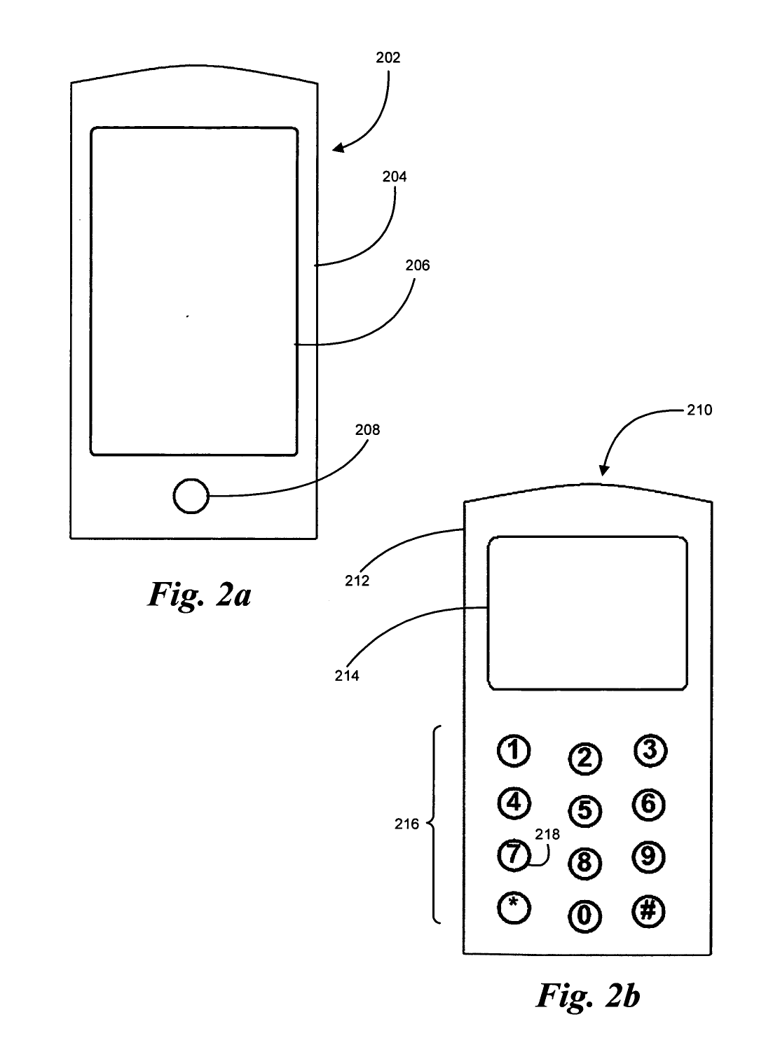

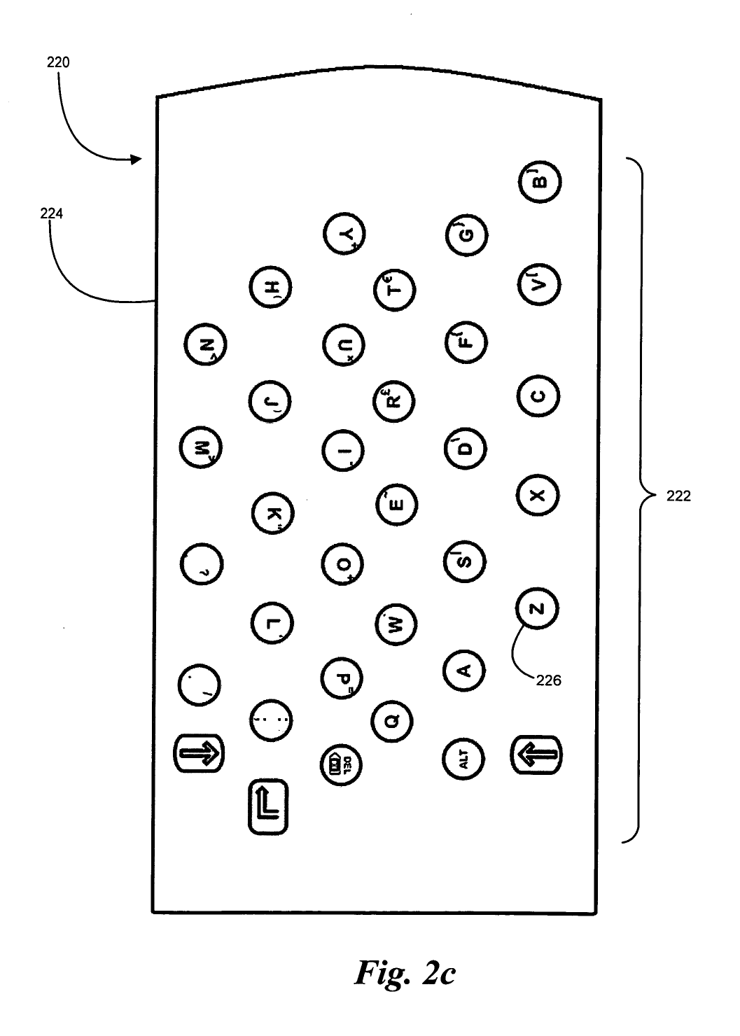

Turning to FIG. 1, depicted is a layout for a keyboard in an embodiment of the present invention. Keyboard 102 comprises a number of keys, for example “Z” key 104, for manual entry of text and data. Each of the twenty-six letters of the standard Roman alphabet has its own key, such as “Z” key 104. In addition, left shift key 106 and right shift key 108 enable the user to access alternative characters from a letter key, such as punctuation marks exemplified by the left parenthesis displayed on key 110 for letter “H”, orthographic characters exemplified by the tilde displayed on key 112 for letter “E”, and symbolic or arithmetic characters exemplified by the “÷” symbol for the division operator displayed on key 114 for letter “Y”. Keyboard 102 further comprises keys for entry of characters for device control, such as “enter” or “carriage return” key 116 and “delete” or “rubout” key 118. Keyboard 102 in this embodiment also comprises “ALT” key 120, discussed further below in reference to FIG. 2c.

Keys for the letters are laid out so that the right half of the keyboard, with keys to be grasped and manipulated by fingers of the user's left hand (as further described below in reference to FIG. 2), is configured in the QWERTY configuration for the left hand, familiar to touch-typists. Similarly, the letter keys on the left half of the keyboard, with keys to be grasped and manipulated by the fingers of the user's right hand, is configured in the QWERTY configuration for the right hand of the touch-typist.

Back-typing using a device with the split keyboard of the present invention is better understood by reference to FIG. 2. FIG. 2a depicts the front side of one embodiment 202 of the present invention, in which, integral to device housing 204, is a touch screen 206 providing both data display and data entry functionalities, as employed in the popular iPhone® and iPod Touch® of Apple, Inc. of Cupertino, Calif. Such devices may further employ one or more physical buttons, such as the depicted button 208, for additional user input functionality. FIG. 2b depicts the front side of the invention in an alternative embodiment 210. In such embodiments, integral to housing 212 is a display screen 214, the relative proportion of which varies widely among such embodiments. In a typical embodiment, screen 214 provides display capabilities only, without touch screen functionality. User input functionality is typically instead provided by keypad 216, comprised of a plurality of keys, such as “7” key 218. The keypad 216 depicted in FIG. 2b is a three-by-four key configuration typically found in cellular telephones and other devices used in telephony-intensive applications. It will be appreciated by those of skill in the art, however, that the front side of the device as depicted in these figures is only exemplary and that many variations in configuration and functionality for the front side of the device, having a display for data output and a touch screen and/or physical keys for data input, are possible within the scope of the present invention.

Turning now to FIG. 2c depicting the back side 220 of the device, a keyboard 222 is disposed within housing 224. Keyboard 222 is comprised of a plurality of physical keys, such as “Z” key 226, advantageously laid out in split configuration as depicted and described above in reference to FIG. 1, which the user depresses with his or her fingers for data entry. Each key of keyboard 226 is either raised or depressed with respect to housing 224 or otherwise individually tactilely distinguishable from the rest of the device so that the user can locate a key by touch alone.

In normal use, the user holds the device in both hands, facing the front side of the device (such as depicted in FIGS. 2a and 2b). The fingers of the user's left hand wrap around the left side of the front of the device and the fingers of the right hand wrap around the right side of the front of the device. With the device so held, the user may position the index finger through little finger of the user's left hand on the back side of the device on the “J”, “K”, “L” and colon/semicolon keys respectively. Simultaneously, the user may position the little finger through index finger of the user's right hand on the back side of the device on the “A”, “S”, “D” and “F” keys respectively.

Persons of skill in the art will recognize that this position of the left and right hands is the “start position” for the “home row” in touch-typing. As is well known in the art, touch-typists are trained to keep their fingers on these keys for typing and/or return them to these keys after pressing any other key that is not in the home row. The layout of the keyboard of the present invention enables a user to use familiar touch-typing memory for the left hand to locate and type keys on the right side (the user's left side) of the device and similarly to use touch-typing memory for the right hand to locate and type keys on the left side (the user's right side) of the device, by tactile and proprioceptive sensation alone, returning the fingers of each hand to the start position after typing. Many punctuation marks, orthographic characters, symbols and other non-alphabetic characters are input, as from a standard keyboard, by depressing an otherwise standard key that is further configured to input such character when depressed (such as associated with the “E”, “H” and “Y” keys discussed above in reference to FIG. 1) when the shift key is also depressed. In the depicted embodiment, for such input a touch-typist user would typically depress the nearby shift key with the little finger of an appropriately chosen hand while using a digit of the other hand for touch-typing the desired character, consistent with modern touch-typing technique. As will be noted by those of skill in the art, while the layout of the alphabetic and some punctuation marks is standardized for the touch-typing keyboard, there is a wide range among touch-typing keyboards in both the set of non-alphabetic characters selected for the keyboard and in the location of such characters in association with specifically positioned keys. It will be understood by persons of skill in the art that the present invention contemplates embodiments over the entire range of such characters and their position in the keyboard layout.

As will be further understood by those in the art, many standard keyboards employ additional keys that, when depressed, enable input of alternate characters by simultaneously depressing standard keys, similar to the functionality provided by shift keys as described above. Such additional keys, exemplified by “ALT” key 120 in FIG. 1, further include such other keys known as “control” or “CTRL”, “function” or “FN”, and the like, and may be implemented with their associated functionality in some layouts in keeping with the spirit of the present invention.

Similarly, again as will be understood by those of skill in the art, many standard keyboards employ keys for device control other than or in addition to the return key and delete key depicted herein (respectively, keys 116 and 118 depicted in FIG. 1). Such keys include the “escape” or “ESC” key, “page up”, “page down”, “home” and “end” keys. Again, such keys and associated functionality may be implemented in some layouts in keeping with the spirit of the present invention.

Accordingly, the keyboard layout of the present invention enables a touch-typist advantageously to employ touch-typing expertise acquired on standard keyboards for text entry on a small form factor device.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. An information device with a split keyboard layout for back-typing, the device having a front face normally facing the user and a back face normally facing away from the user, the device comprising a keyboard disposed on the back side of the device, the keyboard having a right side key configuration and a left side key configuration, the right side key configuration corresponding to the left hand layout of a keyboard adapted to touch-typing and the left side key configuration corresponding to the right hand layout of a keyboard adapted to touch-typing.
